(19) United States
(12) Patent Application Publication
(10) Pub. No.: US 2025/0231104 A1
(43) Pub. Date: Jul. 17, 2025

(54) OPTICAL GAS SENSOR DEVICE, GAS DETECTION METHOD, AND STORAGE MEDIUM STORING PROGRAM

(71) Applicant: MITSUMI ELECTRIC CO., LTD., Tokyo (JP)

(72) Inventor: Akira NAKAMURA, Tokyo (JP)

(73) Assignee: MITSUMI ELECTRIC CO., LTD., Tokyo (JP)

(21) Appl. No.: 18/852,549

(22) PCT Filed: Mar. 16, 2023
(86) PCT No.: PCT/JP2023/010227

§ 371 Date: Sep. 30, 2024

(30) Foreign Application Priority Data
Mar. 31, 2022 (JP) 2022-057888

(51) Int. Cl. G01N 21/3504

(52) U.S. Cl. CPC G01N 21/3504; G01N 2201/06186; G01N 2201/1247; G01N 2201/12723; G01N 2201/1273

(57) ABSTRACT

An optical gas sensor device includes: a light source that emits an infrared ray to a detection target gas; an optical filter that transmits an infrared ray having a wavelength corresponding to an absorption wavelength of the detection target gas; a light receiver that detects the infrared ray entering through the optical filter and generates a detection signal; and a signal processor. The signal processor calculates a gas concentration of the detection target gas or a value corresponding to the gas concentration, based on the detection signal, compares the calculated gas concentration or the calculated value corresponding to the gas concentration with a predetermined threshold, and determines a state of the optical gas sensor device, based on a result of the comparison.

### TECHNICAL FIELD

The present invention relates to an optical gas sensor device, a gas detection method, and a program.

### BACKGROUND ART

Conventionally, gas sensors using a non-dispersive infrared (NDIR) absorption method are known. NDIR gas sensors utilize the property that many gases each absorb a specific infrared wavelength. The NDIR gas sensor emits infrared rays to a detection target gas, detects which wavelength is absorbed and how much, and measures the concentration in the detection target gas. For example, the gas sensor includes an infrared light emitter and an infrared light receiver and detects the concentration in the detection target gas on the optical path of the light emitter and the light receiver.

As a sensor that detects infrared rays, a known infrared sensor includes a thermal infrared detector as a light receiver and a heater for self-examination that heats a hot junction. The infrared sensor energizes the self-examination heater and measures the output of the thermopile (thermocouple) of the thermal infrared detector to self-examine a malfunction, such as a disconnection of the thermopile (see Patent Document 1).

There is also known an infrared detector that includes an electrical heating getter as a light emitter and an infrared detection element as a light receiver. The infrared detector gives currents to the electrical heating getter by a self-examination circuit to generate infrared rays for self-examination, and performs self-examination, based on the output of the infrared detection element (see Patent Document 2).

There is also known a semiconductor infrared detection device that includes an infrared absorption film and a thermocouple as a light receiver and a self-examination circuit. The device detects, with the infrared absorption film and the thermocouple, infrared rays having passed through a hollow connecting to the atmosphere (sealed atmosphere) inside the sealed package and self-examines a malfunction with the self-examination circuit (see Patent Document 3). The sealed atmosphere is in a vacuum state or filled with an inert gas(es).

### CITATION LIST

### Patent Literature

Patent Document 1: Japanese Unexamined Patent Application Publication No. 2011-27652
Patent Document 2: Japanese Unexamined Patent Application Publication No. 2005-98872
Patent Document 3: Japanese Unexamined Patent Application Publication No. H11-153490

### SUMMARY OF INVENTION

### Technical Problem

However, according to the known infrared sensor, the known infrared detector, and the known semiconductor infrared detection device in the above, the self-examination of a malfunction is performed separately from the infrared detection in the normal state. Therefore, even the self-examination is performed for the detection of the detection target gas, abnormalities cannot be detected in the normal gas detection, and accuracy of gas detection may not be ensured. Further, the known infrared sensor, the known infrared detector, and the known semiconductor infrared detection device in the above include a mechanism dedicated for self-examination only. Such a configuration requires a greater number of components and complicated individual components, which results in a complicated device configuration.

An object of the present invention is to ensure accuracy of the gas detection and d simplify the device configuration.

### Solution to Problem

To solve the above problem, according to the present invention, an optical gas sensor device includes: a light source that emits an infrared ray to a detection target gas; an optical filter that transmits an infrared ray having a wavelength corresponding to an absorption wavelength of the detection target gas; a light receiver that detects the infrared ray entering through the optical filter and generates a detection signal; and a signal processor that calculates a gas concentration of the detection target gas or a value corresponding to the gas concentration, based on the detection signal, that compares the calculated gas concentration or the calculated value corresponding to the gas concentration with a predetermined threshold, and that determines a state of the optical gas sensor device, based on a result of the comparison.

Further, according to the present invention,z,999

Further, according to the present invention, there is provided a gas detection method for an optical gas sensor device that includes: a light source that emits an infrared ray to a detection target gas; an optical filter that transmits an infrared ray having a wavelength corresponding to an absorption wavelength of the detection target gas; and a light receiver that detects the infrared ray entering through the optical filter and generates a detection signal, the method including: calculating a gas concentration of the detection target gas or a value corresponding to the gas concentration, based on the detection signal; comparing the calculated gas concentration or the calculated value corresponding to the gas concentration with a predetermined threshold; and determining a state of the optical gas sensor device, based on a result of the comparison.

Further, according to the present invention, there is provided a gas detection method for an optical gas sensor device that includes a board and, on the board, includes: a light source that consists of a thin film heater and that emits an infrared ray; an optical filter that transmits the infrared ray; a light receiver that detects the infrared ray entering through the optical filter and generates a detection signal; and a nonvolatile memory that stores a predetermined threshold for a gas concentration or for a value corresponding to the gas concentration, wherein the optical filter transmits an absorption wavelength specific to the detection target gas, the method including: calculating the gas concentration of the gas having a wavelength transmitted by the optical filter or the value corresponding to the gas concentration; comparing the calculated gas concentration or the calculated value corresponding to the gas concentration with the predetermined threshold; and determining a state of the optical gas sensor device, based on a result of the comparison.

Further, according to the present invention, there is provided a program for a computer of an optical gas sensor device that includes: a light source that emits an infrared ray to a detection target gas; an optical filter that transmits an infrared ray having a wavelength corresponding to an absorption wavelength of the detection target gas; and a light receiver that detects the infrared ray entering through the optical filter and generates a detection signal, the program causing the computer to function as a signal processor that calculates, based on the detection signal, a gas concentration of the detection target gas or a value corresponding to the gas concentration, that compares the calculated gas concentration or the calculated value corresponding to the gas concentration with a predetermined threshold, and that determines a state of the optical gas sensor device, based on a result of the comparison.

Further, according to the present invention, there is provided a program for a computer of an optical gas sensor device that includes a board and, on the board, includes: a light source that consists of a thin film heater and emits an infrared ray; an optical filter that transmits the infrared ray; a light receiver that detects the infrared ray entering through the optical filter and generates a detection signal; and a nonvolatile memory that stores a predetermined threshold for a gas concentration or for a value corresponding to the gas concentration, wherein optical filter transmits an absorption wavelength specific to the detection target gas, the program causing the computer to function as a processor that calculates the gas concentration of the gas having a wavelength transmitted by the optical filter or the value corresponding to the gas concentration, that compares the calculated gas concentration or the calculated value corresponding to the gas concentration with the predetermined threshold, and that determines a state of the optical gas sensor device, based on a result of the comparison.

### Advantageous Effects of Invention

According to the present invention, accuracy of the gas detection can be ensured, and the device configuration can be simplified.

### BRIEF DESCRIPTION OF DRAWINGS

FIG. 1 This is a schematic diagram of an optical gas sensor device according to an embodiment of the present invention.

FIG. 2 This is a perspective view of the optical gas sensor device.

FIG. 3 This is a perspective view of a light source.

FIG. 4 This is a diagram showing the circuit configuration of the optical gas sensor device and an apparatus.

FIG. 5 This is a flowchart showing a state signal generation process.

### DESCRIPTION OF EMBODIMENTS

Hereinafter, an embodiment of the present invention is described in detail with reference to the accompanying drawings. However, the scope of the invention is not limited to the illustrated examples.

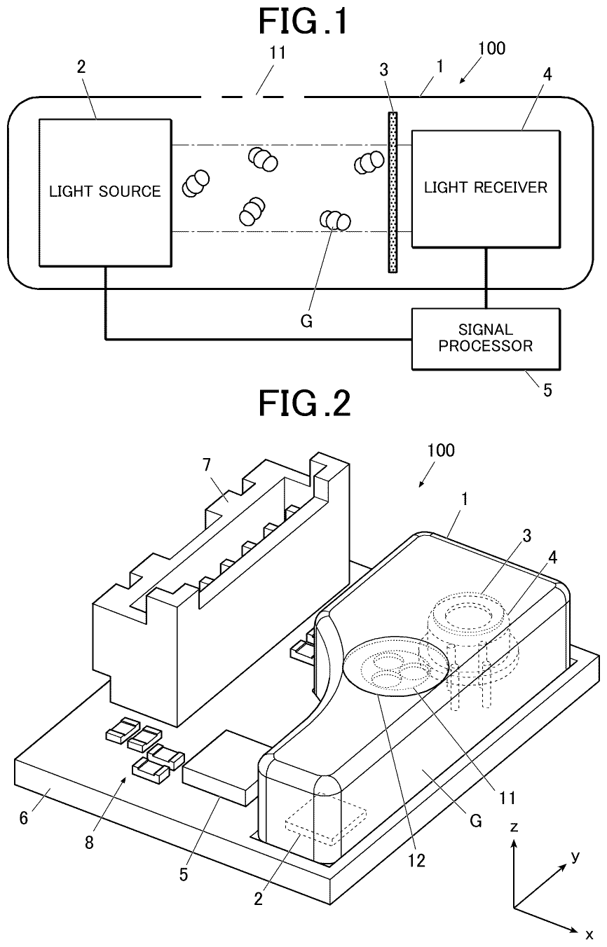

The embodiment according to the present invention is described with reference to FIG. 1 to FIG. 5. First, a schematic configuration of an optical gas sensor device 100 according to the present embodiment is described with reference to FIG. 1. FIG. 1 is a schematic diagram of the optical gas sensor device 100 in this embodiment.

As shown in FIG. 1, the optical gas sensor device 100 in this embodiment includes a cover 1, a light source 2, an optical filter 3, a light receiver 4, and a signal processor 5. The optical gas sensor device 100 is an NDIR gas sensor. The light source 2 emits infrared rays (emits light) and irradiates, with the infrared rays, a detection target (measurement target) gas G in the cover 1 through an optical path in the cover 1. The molecules of the detection target gas G present in the optical path absorb the infrared rays, so that the amount of light reaching the light receiver 4 is reduced. The light receiver 4 detects, via the optical filter 3, the infrared rays partially absorbed by the detection target gas G. The signal processor 5 processes the detection signal, detects (measures) the concentration of the detection target gas G, and outputs the concentration. The cover 1 has a gas introduction port 11 as a gas introduction part that is an inlet/outlet of the detection target gas G. To prevent entrance of foreign matters from outside, a gas filter 12 (e.g., a metal mesh filter or a porous resin film) is put on the gas introduction port 11.

Specifically, the optical gas sensor device 100 filters infrared rays emitted from the light source 2 to the detection target gas G by the optical filter 3 and receives the filtered infrared rays by the light receiver 4. The optical filter 3 is positioned near the light receiver 4 in the upstream of the light receiver 4 on the optical path. Since the filtering is performed on the light receiving surface of the light receiver 4 in this configuration, the area of the optical filter 3 can be reduced and the cost is reduced, as compared with a configuration in which infrared rays emitted by the light source 2 are filtered by the optical filter 3 and then hit the detection target gas G. Further, since infrared rays emitted by sources other than the light source are not received, the signal-to-noise ratio (SN ratio) as a sensor increases. However, the optical gas sensor device 100 may be configured to filter infrared rays emitted from the light source 2 with the optical filter 3 and irradiate the detection target gas G with the filtered infrared rays. The infrared rays to be received by the light receiver 4 may not directly reach the light receiver 4 from the light source but may be reflected on the inner surface of the cover 1 to reach the light receiver 4. It is preferable that the inner surface of the cover 1 have a high reflectance to increase light use efficiency.

Carbon dioxide (CO₂) is used as the detection target gas G, the concentration of which is to be detected. In a case where one identical type of gas has multiple absorption wavelengths, it is preferable that infrared rays having the most absorbed wavelength be detected. For example, the optical gas sensor device 100 detects the absorption of infrared rays having the wavelength of 4.26 [μm], which is most absorbed among the absorption wavelengths of CO₂.

The detection target gas G is not limited to CO₂. The detection target gas G may be carbon monoxide, propane, methane, butane, ammonia, oxygen disulfide, nitrogen dioxide, nitric oxide, ozone, sulfur hexafluoride, difluoromethane, hydrochlorofluorocarbons (HCFC), hydrofluorocarbons (HFC), perfluorocarbons (PFCs), ethylene, or the like.

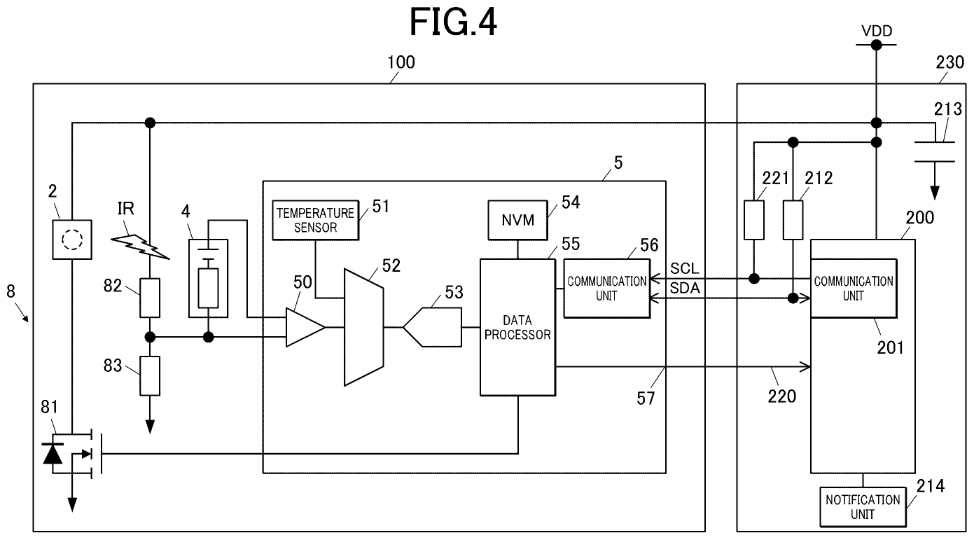

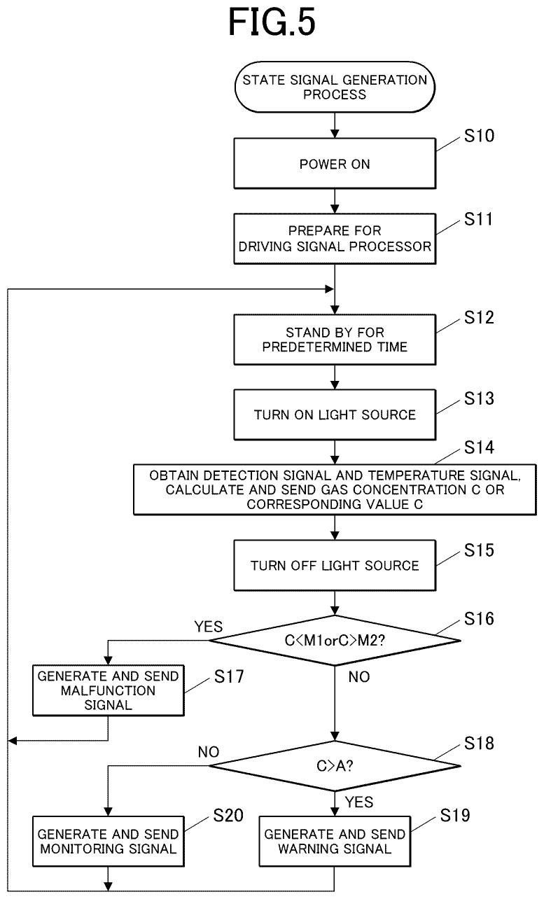

The optical gas sensor device 100 outputs various state signals based on the concentration of the detected gas G to an information processor (a micro controller unit (MCU) 200 shown in FIG. 4, which is described later) of an apparatus that executes processing based on the state of the optical gas sensor device 100. The various state signals include a malfunction signal indicating the malfunction state of the optical gas sensor device 100, a warning signal indicating that the detected concentration of the gas G is in the abnormal state (warning state) and needs to be warned, and a monitoring signal (normal signal) indicating that the detected concentration of the gas G is in the normal state, for example. When the apparatus is an alarm apparatus, the apparatus outputs various alarms corresponding to the various signals received from the optical gas sensor device 100. The various alarms include an alarm indicating a malfunction of the optical gas sensor device 100, based on the malfunction signal, and an alarm indicating an abnormal concentration of the detected gas G, based on the warning signal, for example. The apparatus may include the optical gas sensor device 100 and the MCU 200, or the apparatus may be an apparatus different from the optical gas sensor device 100. For example, the apparatus may be an external apparatus including the MCU 200, as exemplified by an apparatus 230 shown in FIG. 4.

Examples of the apparatus include: a household air conditioning apparatus, a household water heater, an industrial air conditioning apparatus, an automotive air conditioning apparatus, a freezer, a refrigerator, a refrigerator showcase, an air cleaner, a household combustible gas leak alarm, a household toxic gas alarm, a household environmental monitoring apparatus, an industrial combustible gas leak alarm, an industrial toxic gas alarm, an industrial gas process monitoring apparatus, a CO₂ concentration measuring apparatus for horticultural facilities, a CO₂ measuring apparatus for plant factories, a CO₂ containment apparatus for food packaging, and an ethylene gas concentration measuring apparatus for food warehouses. For example, an ammonia monitoring apparatus and a gas leakage alarming apparatus can be applied to the above apparatus. The ammonia monitoring apparatus is for an ammonia tank that stores ammonia as a carrier for hydrogen, which is the fuel of decarbonization, or ammonia as fuel.

In particular, for an apparatus that manages the concentration of the detected gas G itself, such as a household environmental monitoring apparatus, a CO₂ concentration measuring apparatus for horticultural facilities, a CO₂ measuring apparatus for plant factories, and an ethylene gas concentration measuring apparatus for food warehouses, the optical gas sensor device 100 may be configured to output signals corresponding to the detected concentration of the gas G or the value corresponding to the detected concentration of the gas G to the MCU 200 of the apparatus.

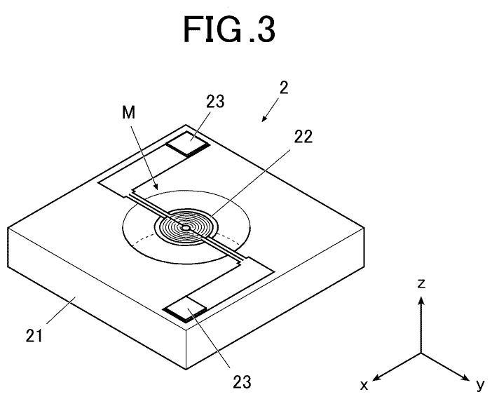

Next, a detailed configuration of the optical gas sensor device 100 is described with reference to FIG. 2 and FIG. 3. FIG. 2 is a perspective view of the optical gas sensor device 100. FIG. 3 is a perspective view of the light source 2.

As shown in FIG. 2, the optical gas sensor device 100 specifically includes the cover 1, the light source 2, the optical filter 3, the light receiver 4, the signal processor 5, a board 6, a connector 7, and circuit elements 8. FIG. 2 shows an X axis, a Y axis, and a Z axis. These three axes are the same in FIG. 3.

The cover 1 is mounted on the +Z side surface of the board 6 to cover (house) the light source 2, the optical filter 3, and the light receiver 4. The cover 1 forms a space in which the detection target gas G can be accommodated. The detection target gas G is let into and let out from the space through the gas introduction port 11. The base body of the cover 1 is made of resin, for example, and has multiple flat or curved inner surfaces. The inner surface of the base body of the cover 1 is covered with an infrared reflective film. The infrared reflective film in this embodiment is gold but is not limited to gold. The infrared reflective film may be silver, aluminum, or a dielectric multilayer membrane. In addition, a protective film, such as silicon oxide or silicon nitride, may be deposited on the infrared reflective film to prevent corrosion of the metal film of the infrared reflective film, if necessary. The infrared reflective film and the protective film can be formed by plating, sputtering, and vacuum vapor deposition.

The cover 1 plays a role as the optical path to efficiently guide infrared rays from the light source 2 to the light receiver 4 by reflecting the infrared rays emitted by the light source 2 on the infrared reflective film so that at least part of the reflected light reaches the light receiver 4 via the optical filter 3. The shape, size and position of the gas introduction port 11 of the cover 1 for the gas G in FIG. 2 are an example and not limited to this.

The light source 2 is a MEMS (Micro Electro Mechanical Systems) type light source mounted on the +z side surface of the board 6. The light source 2 has a membrane M having a membrane structure, for example. As shown in FIG. 3, the light source 2 includes a silicon chip 21, a thin film heater 22, and a wire bonding pad 23. The silicon chip 21 is a semiconductor chip mainly made of silicon and has the membrane M in the center of the surface (x-y surface) of the silicon chip 21. The membrane M is made of a laminated film of silicon oxide and silicon nitride. The surface of the membrane M is substantially parallel to the +Z side surface of the board 6.

The thin film heater 22 is a light source that emits infrared rays and is formed substantially at the center of the surface of the membrane M. The thin film heater 22 is connected to an extraction electrode via a contact portion on the membrane M or around the silicon chip 21 and is electrically connected to the wire bonding pad 23. The materials that can be used as the thin film heater 22 include high melting point metals, such as tungsten (melting point: 3387 [° C.]), rhenium (melting point 3180 [° C.]), tantalum (melting point 2996 [° C.]), osmium (melting point 2700 [° C.]), molybdenum (melting point 2610 [° C.]), niobium (melting point 2468 [° C.]), iridium (melting point 2447 [° C.]), boron (melting point 2300 [° C.]), ruthenium (melting point 2250 [° C.]), or hafnium (melting point 2150 [° C.]); impurity-doped silicon; and a conductive oxide. The membrane M is heated by energization, and the thin film heater 22 emits infrared rays having a strength and wavelength ionicity depending on a surface temperature and a surface emissivity.

The thin film heater 22 is patterned on the silicon chip 21 by lithography, for example. In this embodiment, the silicon chip 21 on which the thin film heater 22 is formed is directly mounted on the board 6 (COB: Chip On Board). However, this is not the limitation. The silicon chip 21 may be housed in a CAN package, a ceramic package, or the like. In such a case, the thin film heater 22 is exposed from the package or configured such that infrared rays from the thin film heater 22 are transmitted. The thin film heater 22 may be covered with a protection plate that transmits infrared rays. The silicon chip 21 has a shape of approximately 3 mm square, for example.

The wire bonding pad 23 is wire-bonded to the wiring on the board 6. Since the thin film heater 22 is formed on the membrane M, the heat capacity of the light source 2 can be lowered, and the thermal efficiency can be increased.

The optical filter 3 is mounted to cover the light receiving surface of the light receiver 4. The optical filter 3 transmits light (infrared rays) in a wavelength range (band) corresponding to the absorption wavelength specific to the detection target gas G. Thus, the transmission wavelength of the optical filter 3 is designed to match the absorption wavelength specific to the detection target gas G. Such a desi suppresses changes of light quantities caused by gases other than the detection target gas G and improves the SN ratio of the detection signal of the light receiver 4. More specifically, the optical filter 3 filters infrared rays of a wide wavelength range entering from the light source 2 and passing through the gas G (CO₂) and transmits infrared rays having a wavelength range corresponding to the absorption wavelength (4.26 μm) of the gas G.

The light source 2 as the MEMS type light source, which is small and low in height, can realize a compact and especially low-in-height sensor module, as compared with a conventional incandescent light source or an LED (Light Emitting Diode).

The light source 2 as the MEMS type light source has characteristics (features), such as long life, low power consumption, and short response time, as compared with a conventional light source. By reducing the power consumption of the light source, which is dominant to the current consumption of the entire sensor module, the power consumption of the sensor module can be reduced. The short response time of the MEMS light source allows shortening the standby time after energization when intermittent driving is performed, thereby reducing average power consumption.

The light source 2 as the MEMS type light source can directly utilize the light emitted from the surface of a high-temperature part, as compared with a known light source. Such a light source 2 can be applied to the detection of gases having absorption bands at high wavelengths. The infrared ray emitting region (thin film heater 22) of the light source 2 is patterned on the surface of the silicon chip 21 with high precision. Unlike a known incandescent light source constituted of a filament wound into a coil, the light source 2 has very small individual variations in the emission direction. Therefore, the light source 2 constituting the sensor module contributes to reducing variations in the amount of received light and improving product yield.

Since the light source 2 is produced in bulk from silicon wafers by the MEMS technology, the light source 2 is excellent in mass production. For example, the light source 2 is manufactured by a method of forming multiple thin film heaters 22 and wire bonding pads 23 on one silicon wafer and dicing the silicon wafer into chips as individual light sources 2. The light source 2 may be manufactured by a method of dicing one silicon wafer into multiple silicon chips 21 and forming a thin film heater 22 and a wire bonding pad 23 on each of the silicon chips 21. Thus, the mounting process of the light source 2 is highly productive since the chipping process and mounting method can be applied as in the manufacture of semiconductors and MEMS devices.

The optical filter 3 includes, for example, a silicon substrate as a substrate and a dielectric multilayer film. The silicon substrate is a flat silicon substrate. The material of the substrate is not limited to silicon but can be Ge (germanium), quartz, alumina, BaF2 (barium fluoride), CaF2 (calcium fluoride), or the like. The dielectric multilayer film is made of layers of dielectrics and is provided on both sides of the silicon substrate. The planar shape of the optical filter 3 is circular but is not limited to this. The planar shape of the optical filter 3 may be other shapes, such as a rectangular shape.

The light receiver 4 is mounted on the +Z side surface of the board 6. The light receiver 4 is a thermopile-type light sensor (infrared sensor) that includes thermocouples. The light receiver 4 detects the amount of incident infrared rays and outputs a detection signal as an analog electric signal. However, the light receiver 4 is not limited to the thermopile-type infrared sensor. The light receiver 4 may be an infrared sensor of various types, as shown in the following TABLE I.

TABLE 1

| | | | Detection | Element |
|---|---|---|---|---|
| Theory of operation | | | wavelength | material |
| Quantum | External | Photoelectric | Ultra-violet | Silver cesium oxide (Ag—O—Cs) |
| type | photoelectric | tube | rays −0.9 | Gallium Arsenide•Cesium(GaAs—Cs) |
| (Cooling | effect | | μm | |
| type) | Internal | Photoconductive | 3-5 μm | Mercury cadmium telluride(HgCdTe) |
| | photoelectric | type | | Indium antimonide(InSb) |
| | effect | | 8-12 μm | Mercury cadmium telluride(HgCdTe) |
| | | | | Gallium arsenide(GaAs) |
| | | | | Aluminum gallium arsenide(AlGaAs) |
| | | | | Quantum Well Infrared Photodetector(QWIP) |
| | | Photovoltaic | 3-5 μm | Platinum silicon(PrSi) |
| | | type | | Indium antimonide(InSb) |
| | | | 8-12 μm | Mercury cadmium telluride(HgCdTe) |
| | | | | Germanium silicon(GeSi) |
| Thermal type | Pyroelectric | Pyroelectric | 1-3 μm | Lead sulfide(PbS) |
| (Non-cooling | effect | element type | 8-12 μm | Barium strontium titanate(BST) |
| type) | | | | Lead zirconate titanate(PZT) |
| | Thermoelectric | Thermocouple | | Polycrystalline silicon(Poly-Si) |
| | effect | type | | |
| | Effect of | Bolometer | | Vanadium oxide(VOx) |
| | change in | type | | Giant Magneto Resistive Effect (CMR) |
| | electrical | | | Yttrium-based superconductor(YBCO) |
| | resistance by | | | Amorphous silicon(a-Si) |
| | temperature | | | |

The light receiver 4 is, for example, an infrared sensor of a CAN package but is not limited to this configuration.

The signal processor 5 is mounted on a surface area other than the cover 1 on the +Z side surface of the board 6. The signal processor 5 is an AFE (Analog Front End)-IC (Integrated Circuit) as an electronic element (processor) that performs signal processing related to the detection signals of the light receiver 4. The signal processor 5 amplifies analog detection signals of the light receiver 4, performs AD conversion, performs correction of individual variations in the optical gas sensor device 100 and so forth, performs signal processing using the amplified digital detection signals to generate various digital signals, and outputs the generated digital signals.

The board 6 is a PCB (Printed Circuit Board) formed of a glass epoxy resin plate or the like on which conductor wiring is printed. The cover 1, the light source 2 (and the optical filter 3), the light receiver 4, the signal processor 5, the connector 7, and the circuit elements 8 are mounted on the +Z side surface of the board 6. The +Z side surface of the board 6 and the light receiving surfaces of the optical filter 3 and the light receiver 4 are substantially parallel to each other.

The connector 7 is mounted on a surface region of the +Z side surface of the board 6 other than the cover 1 and the signal processor 5. The connector 7 outputs various digital signals, which are output by the signal processor 5, to the information processor (MCU 200) of the apparatus 230 (an alarming apparatus) in the post stage. The connector 7 is connected to the MCU 200 of the apparatus 230 via a cable having a plug.

The circuit elements 8 are switches, chip resistors, chip capacitors, and so forth.

Next, the optical path of the infrared rays of the optical gas sensor device 100 is described. In the optical gas sensor device 100, the infrared rays emitted in the +Z direction by the light source 2 are absorbed by the detection target gas G in the cover 1, reflected in the +Y direction and further in the −Z direction by the internal flat surface (or the internal curved surface) of the cover 1, and filtered by the optical filter 3. The filtered infrared rays pass through the optical path that enters the light receiver 4. The optical path is linear on a plane. The optical path of the infrared rays is not limited to the linear optical path on a plane but may be a bended optical path by being reflected on the inner surface of the cover 1 on a plane.

Next, the circuit configuration of the optical gas sensor device 100 is described with reference to FIG. 4. FIG. 4 is a diagram showing the circuit configuration of the optical gas sensor device 100 and the apparatus 230.

As shown in FIG. 4, the optical gas sensor device 100 includes the light source 2, the light receiver 4, the signal processor 5, and the circuit elements 8 as the circuit configuration. The signal processor 5 includes an amplifier 50, a temperature sensor 51, a multiplexer 52, an analog-to-digital (AD) converter 53, an NVM (nonvolatile memory) 54, a data processor 55, a communication unit 56, and a state output terminal 57. The circuit elements 8 include a switch 81 and resistors 82, 83. The optical gas sensor device 100 is connected to the MCU 200 of the apparatus 230. The apparatus 230 includes the MCU 200, resistors 211, 212, a capacitor 213, and a notification unit 214.

The MCU 200 is a controller that controls the components of the apparatus 230 and includes a communication unit 201. The communication units 56 and 201 are serial communication units that use the I2C communication protocol. The communication unit 56 of the optical gas sensor device 100 is connected to the communication unit 201 via a clock line SCL and a data line SDA by the connector 7. The communication unit 201 generates and outputs clock signals to the communication unit 56. The communication unit 56 sends and receives data signals to and from the communication unit 56. The communication protocol of the communication units 56 and 201 is not limited to the IC2. The MCU 200 is connected to the state output terminal 57 via a signal line 220 to receive state signals of the optical gas sensor device 100, which are described later, from the optical gas sensor device 100. Based on the state signals of the optical gas sensor device 100, the MCU 200 controls the notification unit 214. Under the control of the MCU 200, the notification unit 214 notifies the state of the optical gas sensor device 100 by display, by outputting sounds, or the like, based on the state signals.

The power source of the power-supply voltage VDD is connected to the clock line SCL (serial clock) via the resistor 211, connected to the data line SDA (serial data) via the resistor 212, and connected to the ground via the capacitor 213. The resistors 211, 212 are pull-up resistors. The capacitor 213 removes the noise of the power-supply voltage VDD.

The light source 2 and the switch 81 are connected in series between the power source of the power-supply voltage VDD and the ground. The switch 81 is for switching on and off the light source 2 and is constituted of an NMOSFET (N-channel Metal-Oxide-Semiconductor Field Effect Transistor) and so forth. The gate of the switch 81 as the control terminal is connected to the signal processor 5. The resistors 82, 83 are connected in series between the power source of the power-supply voltage VDD and the ground. The node between the resistors 82, 83 is connected to the input terminal of the light receiver 4. The power-supply voltage divided by the resistors 82, 83 is input to the input terminal of the light receiver 4. The light receiver 4 detects the infrared rays IR, which are emitted by the light source 2 and input via the gas G and the optical filter 3, and outputs analog detection signals from the output terminal.

The power-supply voltage divided by the resistors 82, 83 is input to the first input terminal of the amplifier 50. The output terminal of the light receiver 4 is connected to the second input terminal of the amplifier 50. By using the input divided power-supply voltage and the input detection signal from the light receiver 4, the amplifier 50 amplifies the analog detection signal output by the light receiver 4.

The output terminal of the amplifier 50 is connected to one of the input terminals of the multiplexer 52. The temperature sensor 51 is connected to one of the input terminals of the multiplexer 52. The temperature sensor 51 detects the temperature in the cover 1, generates an analog temperature signal, and outputs the generated analog temperature signal to the input terminal of the multiplexer 52.

For example, in response to the signal selection control of the data processor 55, the multiplexer 52 performs multiplexing of the analog detection signal, which is input by the light receiver 4 and amplified, and the analog temperature signal, which is input by the temperature sensor 51, into one analog multiplex signal. The multiplexer 52 outputs the one analog multiplex signal to the input terminal of the AD converter 53. The AD converter 53 converts the input multiplex signal to a multiplex signal of a digital detection signal of the light receiver 4 and a digital temperature signal, and outputs the converted signal to the data processor 55.

The NVM 54 is a nonvolatile memory for storing information. For example, the NVM 54 stores thresholds M1, M2, and A for the concentration C of the gas G, a predetermined time, and a correction factor, which are described later. The threshold M1 is for determining the malfunction state and the normal state (non-malfunction state) of the optical gas sensor device 100. The threshold M1 is the lowest limit of the gas concentration C of the gas G or the value C corresponding to the gas concentration in the normal state. The threshold M2 is for determining the malfunction state and the normal state (non-malfunction state) of the optical gas sensor device 100. The threshold M2 is the upper limit of the malfunction state of the gas concentration C of the gas G or the value C corresponding to the gas concentration in the normal state. The threshold A is for determining a warning state and the normal state (non-warning state) of the optical gas sensor device 100. The threshold A is the upper limit of the gas concentration C of the gas G or the value C corresponding to the gas concentration in the normal state. The thresholds satisfy the relationship of M2>A>M1. The predetermined period is a period determined beforehand for indicating timing to determine the state of the optical gas sensor device 100. The predetermined period is two seconds, for example. The correction factor is for performing correction processing to correct individual variations and so forth of the optical gas sensor device 100.

The data processor 55 is the main control part (processor) that performs signal processing related to the detection signals of the light receiver 4. The data processor 55 includes a CPU (Central Processing Unit), a RAM (Random Access Memory), and a storage, for example. The CPU controls the optical gas sensor device 100. The RAM is a volatile memory and temporarily stores information. The storage is constituted of a nonvolatile memory (NVM) like a ROM (Read Only Memory). The storage stores various kinds of data and programs. The NVM 54, which is a nonvolatile memory configured separately from the data processor 55, may serve as the storage. The NVM 54 can be a mask ROM, an EPROM (Erasable Programmable Read Only Memory), EEPROM (Electrically Erasable Programmable Read Only Memory), a flash memory, or the like. The CPU of the data processor 55 reads a program stored in the storage, loads the program into the RAM, and executes various kinds of processing in cooperation with the loaded program. The storage stores a state signal generation program for executing a state signal generation process to be described later.

The data processor 55 calculates the gas concentration C of the gas G or the value C corresponding to the gas concentration by using the digital detection signal of the light receiver 4 and the digital temperature signal, which are input by the multiplexer 52, and the correction factor stored in the NVM 54. The data processor 55 compares the calculated gas concentration C or the calculated value C corresponding to the gas concentration with the thresholds M1, M2, and A, which are stored in the NVM 54. Based on the comparison, the data processor 55 generates various state signals (malfunction signal, warning signal, and monitoring signal to be described later) of the optical gas sensor device 100. The data processor 55 sends, via the communication unit 56, the gas concentration C or the value C corresponding to the gas concentration to the MCU 200 of the apparatus 230. The data processor 55 also sends, via the state output terminal 57, the state signal of the optical gas sensor device 100 in a predetermined format to the MCU 200. The data processor 55 may be constituted of a circuit, such as an FPGA (Field Programmable Gate Array) or an ASIC (Application Specific Integrated Circuit).

The communication unit 56 sends and receives data signals to and from the communication unit 201 via the data line SDA.

Next, the operation of the data processor 55 of the signal processor 5 is described as the operation of the optical gas sensor device 100 with reference to FIG. 5. FIG. 5 is a flowchart showing the state signal generation process.

The optical gas sensor device 100 is connected to the MCU 200 of the apparatus 230 beforehand. The detection target gas G is: introduced inside the cover 1 through the gas introduction port 11 beforehand.

The data processor 55 of the signal processor 5 starts the state signal generation process in accordance with the state signal generation program stored in the internal storage, in response to the user turning on the optical gas sensor device 100 (Step S10).

First, the data processor 55 prepares for driving the signal processor 5 by initializing the signal processor 5 and so forth (Step S11). The data processor 55 reads the predetermined time, which is set and stored in the NVM 54 beforehand, and stands by for the predetermined time (Step S12).

The data processor 55 switches on the switch 81 to turn on the light source 2 (Step S13). The data processor 55 obtains the temperature signal and the detection signal of the detection target gas G, which has been output by the light receiver 4, amplified by the amplifier 50 and converted from analog to digital by the AD converter 53; the data processor 55 performs, the obtained detection signal, correction processing for correcting individual variations of the optical gas sensor device 100 by using the correction factor stored in the NVM 54 to which the temperature signal is applied; the data processor 55 calculates the gas concentration C of the gas G or the value C corresponding to the gas concentration of the gas G, based on the corrected detection signal; and the data processor 55 sends the gas concentration C of the gas G or the value C corresponding to the gas concentration C of the gas G to the MCU 200 via the communication unit 56 (Step S14).

The data processor 55 turns off the light source 2 by switching off the switch 81 (Step S15). The data processor 55 reads the thresholds M1, M2 stored in the NVM 54, compares the gas concentration C or the value C corresponding to the gas concentration of the gas G obtained in Step S14 with the thresholds M1, M2, and determines whether either C<M1 or C>M2 is satisfied or not (Step S16).

When either C<M1 or C>M2 is satisfied (Step S16: YES), the data processor 55 generates the malfunction signal indicating the malfunction state in which a malfunction occurs in the optical gas sensor device 100, based on C<M1 or C>M2, and sends the malfunction signal to the MCU 200 via the state output terminal 57 (Step S17). The data processor 55 then proceeds to Step S12. The malfunction state in the case of C<M1 is referred to as a first malfunction mode. The first malfunction mode corresponds to cases where the light source 2 stops outputting light; the light receiver 4 stops operating; or the cover 1 is damaged and the amount of received light is decreased. The malfunction state in the case of C>M2 is referred to as a second malfunction mode. The second malfunction mode corresponds to a case where the light receiver 4 is damaged and the signal processor 5 receives abnormal inputs. It is preferable that the malfunction signal include information indicating which mode is occurring, the malfunction mode of C<M1 or the malfunction mode of C>M2.

In response to Step S17, the MCU 200 of the apparatus 230 receives the malfunction signal from the optical gas sensor device 100 and causes the notification unit 214 of the apparatus 230 to notify information indicating occurrence of a malfunction (and the malfunction mode) by display or by outputting sounds. In the case, the notification unit 214 is provided with a notification means to indicate the state of the optical gas sensor device 100, such as a signal device constituted of an LED (Light Emitting Diode) or the like, a display constituted of liquid crystal or organic Electro-Luminescence (EL), and a speaker for outputting sounds. Further, the MCU 200 sends a trigger signal for starting appropriate ventilation operations to a unit that performs ventilation operations and so forth and that is connected to the MCU 200, via the communication unit 56 or the state output terminal 57.

When neither C<M1 nor C>M2 is satisfied (when M1≤C≤M2 is satisfied and the state is not the malfunction state) (Step S16: NO), the data processor 55 reads the threshold A stored in the NVM 54, compares the gas concentration C of the gas G or the value C corresponding to the gas concentration, which is obtained in Step S14, with the threshold A, and determines whether C>A is satisfied or not (Step S18). When C>A is satisfied (Step S18: YES), the data processor 55 determines that the state is the warning state in which a leak of the gas G occurs, based on C>A; and the data processor 55 generates the warning signal indicating the warning state of the optical gas sensor device 100 and sends the warning signal to the MCU 200 via the state output terminal 57 (Step S19). The data processor 55 then proceeds to Step S12.

In response to Step S19, the MCU 200 of the apparatus 230 receives the warning signal from the optical gas sensor device 100 and causes the notification unit 214 of the apparatus 230 to notify warning of the gas G leakage by display, by outputting sounds, or the like.

When C>A is not satisfied (when C≤A is satisfied and the state is not the warning state) (Step S18: NO), the data processor 55 determines that the state is the normal state in which the gas G leakage is not occurring based on C>A; and the data processor 55 generates the monitoring signal indicating the normal state of the optical gas sensor device 100 and outputs the monitoring signal to the MCU 200 via the state output terminal 57 (Step S20). The data processor 55 then proceeds to Step S12.

In response to Step S20, the MCU 200 of the apparatus 230 receives the monitoring signal from the optical gas sensor device 100. The MCU 200 does not perform notification of warning but may cause the notification unit 214 of the apparatus 230 to notify the normal state by display, by outputting sounds, or the like.

In Step S17, S19 or S20, the data processor 55 may be configured to send the malfunction signal, the warning signal, or the monitoring signal to the MCU 200 via the communication unit 56. In Step S14, the data processor 55 may be configured not to send the calculated gas concentration C of the gas G or the calculated value C corresponding to the gas concentration to the MCU 200.

As described above, according to the embodiment, the optical gas sensor device 100 includes: the light source 2 that emits infrared rays to the detection target gas G; the optical filter 3 that transmits infrared rays having a wavelength corresponding to the absorption wavelength of the detection target gas G; the light receiver 4 that detects the infrared rays entering via the optical filter 3 and generates a detection signal; and the signal processor 5 that calculates a gas concentration of the detection target gas G or a value corresponding to the gas concentration, based on the detection signal, that compares the calculated gas concentration or the calculated value corresponding to the gas concentration with a predetermined threshold, and that determines the state of the optical gas sensor device 100, based on the result of the comparison.

The optical gas sensor device 100 includes the board 6 and, on the board 6, includes the light source 2, the optical filter 3, the light receiver 4, and the signal processor 5 (the data processor 55 that performs signal processing related to the detection signal and the NVM 54 that stores predetermined thresholds for the gas concentration C or the value C corresponding to the gas concentration).

Thus, the state of the optical gas sensor device is determined, based on the gas concentration C or the value C corresponding to the gas concentration of the gas C that was calculated based on the actually detected gas G. This ensures accuracy of the detection of the gas G. The accuracy is important in industrial applications where accurate operations are necessary or applications where a measurement error can lead to a serious accident, such as measurement of combustible gas or toxic gas. Further, the state is detected (determined) every time the gas concentration C or the value C corresponding to the gas concentration is detected and calculated. Therefore, occurrence of abnormality can be swiftly detected. Since there is no need of additional components for performing the state detection (self-examination), an increase in the number of components and complexity of individual components is avoided. Thus, the configuration of the optical gas sensor device 100 can be simplified, and the cost can be reduced. Further, there is no need to turn on the light source 2 merely for performing the self-examination (state detection). This leads to the reduction of power consumption and prevents deterioration of the light source 2 over time. Further, there is no need to heat the light receiver 4 for performing the state detection. This can prevent deterioration of the light receiver 4 caused by the self-examination.

The threshold includes the threshold M1 and the threshold M2 for determining the malfunction state of the optical gas sensor device 100. The threshold M2 is greater than the threshold M1. When the calculated gas concentration or the calculated value corresponding to the gas concentration is less than the threshold M1 or greater than the threshold M2, the signal processor 5 determines that the optical gas sensor device is in the malfunction state. Thus, the malfunction state of the optical gas sensor device can be accurately determined.

The threshold includes the threshold A for determining the warning state of the optical gas sensor device 100 in which a gas G leakage is occurring. When the calculated gas concentration C or the calculated value C corresponding to the gas concentration is greater than the threshold A, the signal processor 5 determines that the optical gas sensor device is in the warning state. Thus, the warning state of the optical gas sensor device can be accurately determined.

The signal processor 5 sends a state signal (malfunction signal, warning signal, or monitoring signal) to the apparatus 230, the state signal indicating the determined state of the optical gas sensor device 100. Specifically, the signal processor 5 determines generation of warning, based on the calculated gas concentration C or the calculated value C corresponding to the gas concentration (the signal processor 5 determines to send the state signal of the warning signal to the apparatus 230, and sends the signal). Such a configuration allows the apparatus 230 to perform processing based on the state signal (malfunction signal, warning signal, and monitoring signal), such as notification of the state based on the state signal.

The signal processor 5 sends the calculated gas concentration C or the calculated value C corresponding to the gas concentration to the apparatus 230. Such a configuration allows the apparatus 230 to perform processing based on the gas concentration C or the value C corresponding to the gas concentration, such as managing the gas concentration C or the value C corresponding to the gas concentration.

The optical gas sensor device 100 includes the board 6 and, on the board 6, includes: the cover 1 mounted to cover the light source 2 and the light receiver 4 such that the infrared rays passing through the optical filter 3 is reflected on the inner surface of the cover 1 and at least part of the reflected light reaches the light receiver 4; and the gas introduction port 11 that introduces the detection target gas G to the inside of the cover 1. Thus, the gas concentration C or the value C corresponding to the gas concentration of the gas G in the cover 1 can be accurately detected, and the state of the optical gas sensor device can be accurately determined Thus, accuracy in detection of the gas G can be ensured.

The signal processor 5 turns on the light source 2 to obtain the detection signal of the detection target gas G by the light receiver 4 (and calculates and sends the gas concentration C of the detection target gas G or the value C corresponding to the gas concentration). The signal processor 5 then turns off the light source 2. Thus, the lighting time of the light source 2 is shortened. This reduces power consumption and further restrains the deterioration of the light source 2 over time. The signal processor 5 (data processor 55) may be configured to calculate and send the gas concentration C of the gas G or the value C corresponding to the gas concentration after the light source 2 is turned off (after Step S15).

The optical gas sensor device 100 includes the switch 81 for switching on and off the light source 2. The signal processor 5 controls the switch 81 to turn on or off the light source 2. Thus, the signal processor 5 can easily and accurately turn on and off the light source 2.

The embodiment described above is an example of the optical gas sensor device, the gas detection method, and the program of the present invention, and does not limit the present invention.

For example, although the optical gas sensor device 100 in the above embodiment includes a combination of the light source 2, the optical filter 3, and the light receiver 4, the present invention is not limited to this. The optical gas sensor device may include multiple combinations of the light source 2, the optical filter 3, and the light receiver 4.

The detailed configuration and detailed operation of the optical gas sensor device 100 in the above embodiment may be appropriately modified within the scope of the present invention.

### INDUSTRIAL APPLICABILITY

As described above, the optical gas sensor device, the gas detection method, and the program according to the present invention are appropriate for detecting a gas, such as CO₂.

### REFERENCE SIGNS LIST

100 Optical gas sensor device
G Gas
1 Cover
11 Gas introduction port
12 Gas filter
2 Light source
21 Silicon chip
22 Thin film heater
23 Wire bonding pad
M Membrane
3 Optical filter
4 Light receiver
5 Signal processor
50 Amplifier
51 Temperature sensor
52 Multiplexer
53 AD converter
54 NVM
55 Data processor
56 Communication unit
SCL Clock line
SDA Data line
6 Board
7 Connector
8 Circuit elements
81 Switch
82, 83 Resistors
230 Apparatus
200 MCU
201 Communication unit
211, 212 Resistors
213 Capacitor
214 Notification unit
220 Signal line

1. An optical gas sensor device comprising:
a light source that emits an infrared ray to a detection target gas;
an optical filter that transmits an infrared ray having a wavelength corresponding to an absorption wavelength of the detection target gas;
a light receiver that detects the infrared ray entering through the optical filter and generates a detection signal; and
a signal processor that calculates a gas concentration of the detection target gas or a value corresponding to the gas concentration, based on the detection signal, that compares the calculated gas concentration or the calculated value corresponding to the gas concentration with a predetermined threshold, and that determines a state of the optical gas sensor device, based on a result of the comparison.

2. The optical gas sensor device according to claim 1, wherein
the threshold includes a first threshold and a second threshold for determining a malfunction state of the optical gas sensor device, the second threshold being greater than the first threshold; and
when the calculated gas concentration or the calculated value corresponding to the gas concentration is less than the first threshold or greater than the second threshold, the signal processor determines that the optical gas sensor device is in the malfunction state.

3. The optical gas sensor device according to claim 1, wherein
the threshold includes a third threshold for determining a warning state of the optical gas sensor device, the warning state corresponding to an occurrence of a gas leakage; and
when the calculated gas concentration or the calculated value corresponding to the gas concentration is greater than the third threshold, the signal processor determines that the optical gas sensor device is in the warning state.

4. The optical gas sensor device according to claim 1, wherein the signal processor sends a state signal indicating the determined state of the optical gas sensor device to an apparatus.

5. The optical gas sensor device according to claim 4, wherein the signal processor sends the calculated gas concentration or the calculated value corresponding to the gas concentration to the apparatus.

6. The optical gas sensor device according to claim 1, comprising a board and, on the board, comprising:
a cover mounted to cover the light source and the light receiver such that the infrared ray passing through the optical filter is reflected on an inner surface of the cover and at least part of the reflected light reaches the light receiver; and
a gas introduction part that introduces the detection target gas to an inside of the cover.

7. The optical gas sensor device according to claim 1, wherein the signal processor turns on the light source to obtain the detection signal of the detection target gas and turns off the light source.

8. The optical gas sensor device according to claim 7, comprising a switch for switching on and off the light source, wherein the signal processor controls the switch to turn on or off the light source.

9. (canceled)

10. (canceled)

11. A gas detection method for an optical gas sensor device that includes:
a light source that emits an infrared ray to a detection target gas;
an optical filter that transmits an infrared ray having a wavelength corresponding to an absorption wavelength of the detection target gas; and
a light receiver that detects the infrared ray entering through the optical filter and generates a detection signal, the method comprising:
calculating a gas concentration of the detection target gas or a value corresponding to the gas concentration, based on the detection signal;
comparing the calculated gas concentration or the calculated value corresponding to the gas concentration with a predetermined threshold; and
determining a state of the optical gas sensor device, based on a result of the comparison.

12. (canceled)

13. The gas detection method according to claim 11, comprising determining generation of warning, based on the calculated gas concentration or the calculated value corresponding to the gas concentration, after determining the state of the optical gas sensor device.

14. A non transitory computer-readable storage medium storing a program for a computer of an optical gas sensor device that includes:
a light source that emits an infrared ray to a detection target gas;
an optical filter that transmits an infrared ray having a wavelength corresponding to an absorption wavelength of the detection target gas; and
a light receiver that detects the infrared ray entering through the optical filter and generates a detection signal,
the program causing the computer to function as a signal processor that calculates, based on the detection signal, a gas concentration of the detection target gas or a value corresponding to the gas concentration, that compares the calculated gas concentration or the calculated value corresponding to the gas concentration with a predetermined threshold, and that determines a state of the optical gas sensor device, based on a result of the comparison.

15. (canceled)
